(19) United States
(12) Patent Application Publication
(10) Pub. No.: US 2025/0373431 A1
(43) Pub. Date: Dec. 4, 2025

(54) TOKEN CONTROL SYSTEM THAT VERIFIES TOKEN AND AUTHORIZES USER TERMINAL TO EXECUTE APPLICATION, COMPUTER-READABLE, NON-TRANSITORY RECORDING MEDIUM HAVING TOKEN CONTROL PROGRAM RECORDED THEREON, AND APPLICATION PROVISION SYSTEM

(71) Applicant: KYOCERA Document Solutions Inc., Osaka (JP)

(72) Inventor: Koki NAKAJIMA, Osaka (JP)

(73) Assignee: KYOCERA Document Solutions Inc., Osaka (JP)

(21) Appl. No.: 19/219,618

(22) Filed: May 27, 2025

(30) Foreign Application Priority Data
May 30, 2024 (JP) 2024-088142

(51) Int. Cl. H04L 9/32

(52) U.S. Cl. CPC H04L 9/3213

(57) ABSTRACT

A token control system includes a communication device and a token controller. The communication device communicates with an external device. The token controller controls a token necessary for executing an application that acts on a platform. The token is key-value type data including a key serving as identification information of the token, and values representing contents of the token. When the communication device receives the key transmitted from a user terminal, and the tokens published by the platform, and stored in a predetermined token storage, include a token including the key received by the communication device, the token controller authorizes the user terminal to execute the application.

### INCORPORATION BY REFERENCE

This application claims priority to Japanese Patent Application No.2024-088142 filed on May 30, 2024, the entire contents of which are incorporated by reference herein.

### BACKGROUND

The present disclosure relates to token control system that controls a token necessary for executing an application, a computer-readable, non-transitory recording medium having a token control program recorded thereon, and an application provision system.

A technique is generally known by which a computer that publishes applications releases a token to a client, so that the client can utilize the application by presenting the token.

### SUMMARY

The disclosure proposes further improvement of the foregoing technique.

In an aspect, the disclosure provides a token control system including a communication device and a token controller. The communication device communicates with an external device. The token controller includes a processor, and controls a token necessary for executing an application that acts on a platform, when the processor executes a token control program. The token is key-value type data composed of a key serving as identification information of the token, and values representing contents of the token. When the communication device receives the key transmitted from a user terminal, and the tokens published by the platform, and stored in a predetermined token storage, include a token including the key received by the communication device, the token controller authorizes the user terminal to execute the application.

In another aspect, the disclosure provides a computer-readable, non-transitory recording medium having a token control program recorded thereon. The token control program is configured to cause a computer including a communication device that communicates with an external device, and a processor, to act as a token controller when the processor executes the token control program. The token controller controls a token necessary for executing an application that acts on a platform. The token is key-value type data key-value type a key serving as identification information of the token, and values representing contents of the token. When the communication device receives the key transmitted from a user terminal, and the tokens published by the platform, and stored in a predetermined token storage, include a token including the key received by the communication device, the token controller authorizes the user terminal to execute the application.

In still another aspect, the disclosure provides an application provision system including a platform, an application, a communication device, a token controller, and a token storage. The application acts on a platform. The communication device communicates with an external device. The token controller includes a processor, and controls a token necessary for executing the application that acts on the platform, when the processor executes a token control program. The token storage stores therein tokens published by the platform. The token is key-value type data key-value type a key serving as identification information of the token, and values representing contents of the token. When the communication device receives the key transmitted from a user terminal, and the tokens stored in the token storage, include a token including the key received by the communication device, the token controller authorizes the user terminal to execute the application.

### BRIEF DESCRIPTION OF THE DRAWINGS

FIG. 1 is a block diagram showing a configuration of an information processing system;

FIG. 2 is a block diagram showing a configuration of an application provision system;

FIG. 3A presents an example of a tenant management table;

FIG. 3B presents an example of a user management table;

FIG. 3C presents an example of a role management table;

FIG. 4 is a block diagram showing a configuration of a token control system constituted of a single computer;

FIG. 5 is a block diagram showing a configuration of a cache system constituted of a single computer;

FIG. 6 is a block diagram showing a configuration of a control device of the cache system;

FIG. 7 presents an example of the token;

FIG. 8 is a block diagram showing a configuration of a user terminal constituted of a PC;

FIG. 9 is a block diagram showing a configuration of a control device of the user terminal;

FIG. 10 is a sequence chart showing an operation of the information processing system, performed when a user logs in to the application provision system;

FIG. 11 is a sequence chart showing an operation of the information processing system, performed when the user utilizes an application; and

FIG. 12 is a sequence chart showing an operation of the information processing system, performed when the application acquires the content of the token.

### DETAILED DESCRIPTION

Hereafter, an embodiment of the disclosure will be described, with reference to the drawings.

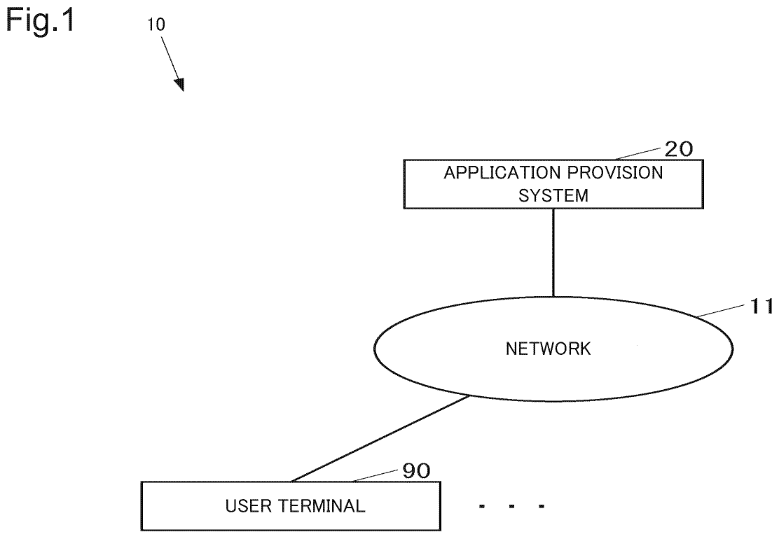

First, a configuration of the information processing system according to the embodiment of the disclosure will be described. FIG. 1 is a block diagram showing the configuration of the information processing system 10 according to the embodiment.

As shown in FIG. 1, the information processing system 10 includes an application provision system 20 that provides an application to be utilized by a user. The application provision system 20 is constituted of a plurality of computers. The application provision system 20 may be realized on an on-premise basis, or on the cloud.

The information processing system 10 includes a user terminal 90 to be utilized by the user. The information processing system 10 may additionally include one or more user terminals configured similarly to the user terminal 90. The user terminal may be constituted of, for example, a personal computer (PC).

The user terminal 90 and the application provision system 20 can communicate with each other, via a network 11 such as a local area network (LAN) or the internet.

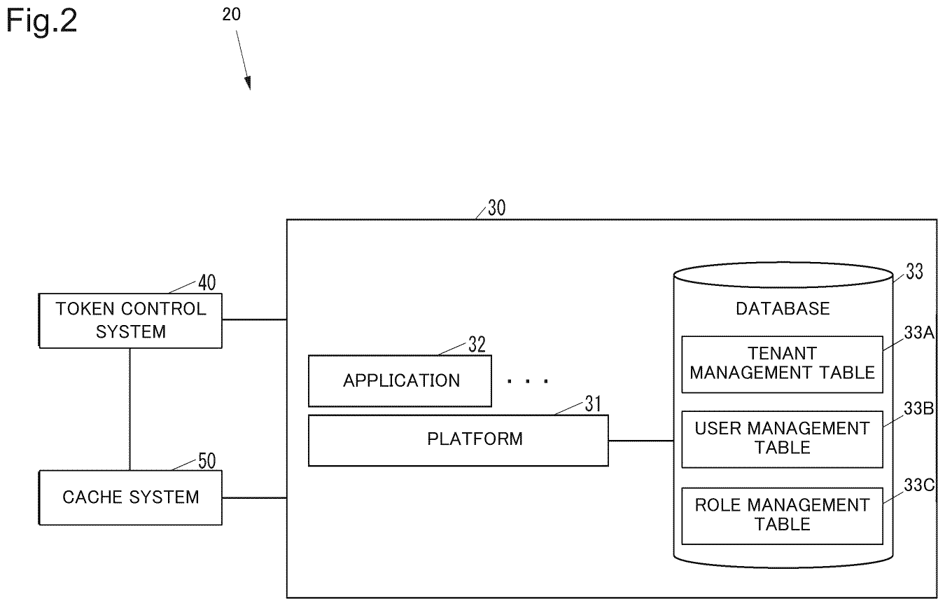

FIG. 2 is a block diagram showing a configuration of the application provision system 20. As shown in FIG. 2, the application provision system 20 includes an application execution system 30 that executes an application utilized by the user, a token control system 40 that controls the token necessary for executing the application, and a cache system 50 that retains the token.

The application execution system 30, the token control system 40, and the cache system 50 may each be constituted of a single computer such as a PC, or a plurality of computers.

Hereinafter, it will be assumed that the uniform resource locator (URL) for making access to the token control system 40 is “https://example.com/auth”.

The application execution system 30 includes a platform 31 for executing the application utilized by the user.

The application execution system 30 includes the application 32, executed on the platform 31 and utilized by the user. The application execution system 30 may include at least one application to be executed on the platform 31 and utilized by the user, in addition to the application 32.

The application execution system 30 includes a database 33, for managing information utilized by the platform 31 and the application 32.

The database 33 includes a tenant management table 33A for managing a tenant to which the user belongs, a user management table 33B for managing the users, and a role management table 33C for managing roles that may be assigned to the user.

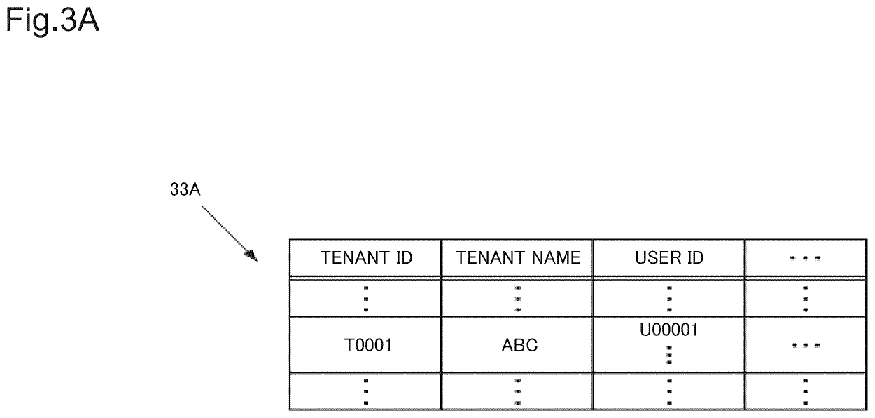

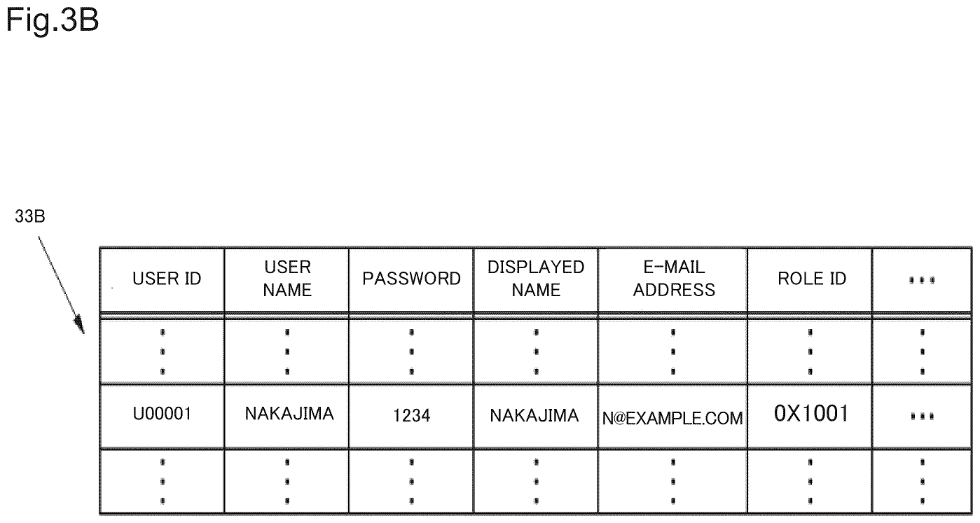

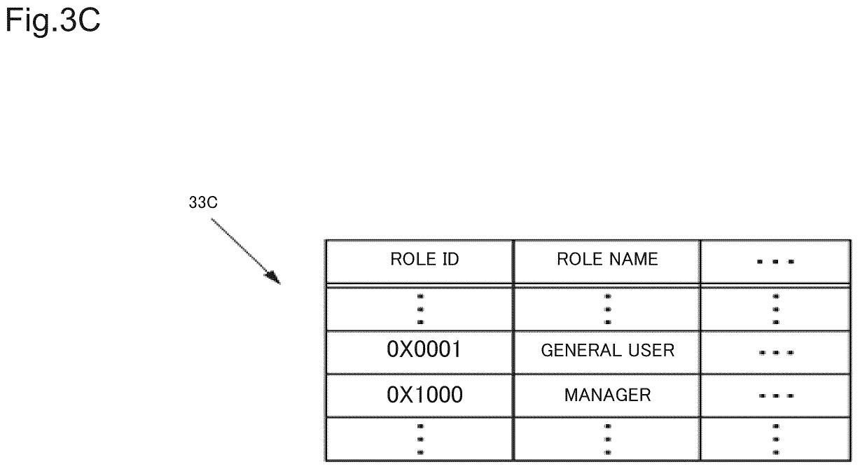

FIG. 3A resents an example of the tenant management table 33A. FIG. 3B presents an example of the user management table 33B. FIG. 3C presents an example of the role management table 33C.

A tenant ID, serving as the identification information in the database 33, is assigned to the tenant. A user ID, serving as the identification information in the database 33, is assigned to the user. A role ID, serving as the identification information in the database 33, is assigned to the role. The role ID is expressed in a hexadecimal number.

As shown in FIG. 3A, the tenant management table 33A includes the tenant ID, the tenant name, and the user ID of each user belonging to the tenant, in association with each other, with respect to each of the tenants. FIG. 3A only shows a part of the content of the tenant management table 33A.

As shown in FIG. 3B, the user management table 33B includes the user ID, the user name, the password of the user, the user name to be displayed on the screen provided by the application provision system 20, the e-mail address of the user, and the role ID of the role assigned to the user, in association with each other, with respect to each of the users. FIG. 3B only shows a part of the content of the user management table 33B.

As shown in FIG. 3C, the role management table 33C includes the role ID and the role name in association with each other, with respect to each of the roles. FIG. 3C only shows a part of the content of the role management table 33C.

In the user management table 33B, the role ID of the role assigned to the user is expressed by the sum of the role IDs of all the roles assigned to the user. For example, “0x1001” is the sum of “0x0001” and “0x1000”. Therefore, the user assigned with the role ID “0x1001” in the user management table 33B corresponds to the user assigned with the role of a general user, associated with the role ID “0x0001” in the role management table 33C, and assigned with the role of a manager, associated with the role ID “0x1000” in the role management table 33C.

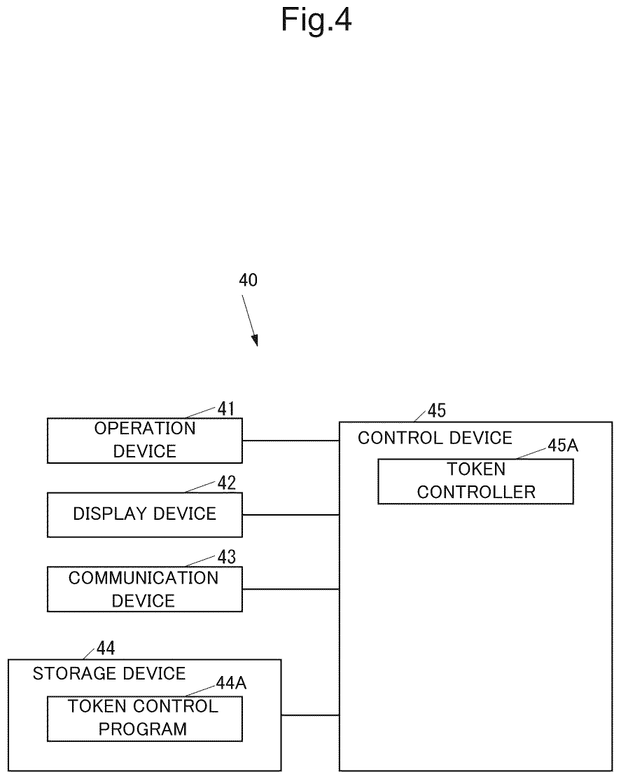

FIG. 4 is a block diagram showing a configuration of the token control system 40 constituted of a single computer. As shown in FIG. 4, the token control system 40 includes an operation device 41, a display device 42, a communication device 43, a storage device 44, and a control device 45.

The operation device 41 includes, for example, a keyboard and a mouse for inputting various operations. The display device 42 includes, for example, a liquid crystal display (LCD) for displaying various types of information. The communication device 43 performs communication with an external device, via a network such as a local area network (LAN) or the internet, or directly through wired or wireless communication. The storage device 24 includes a non-volatile memory unit such as a semiconductor memory or a hard disk drive (HDD), for storing various types of information. The control device 45 controls the overall operation of the token control system 40.

The storage device 44 can store therein a token control program 44A, for controlling the token. The token control program 44A may be, for example, installed in the token control system 40 during the manufacturing process thereof, additionally installed in the token control system 40 from an external storage medium such as a universal serial bus (USB) memory, or additionally installed in the token control system 40 from the network.

The control device 45 includes, for example, a central processing unit (CPU), a read-only memory (ROM) containing programs and various types of data, and a random-access memory (RAM) serving as the operating region for the CPU of the control device 45. The CPU of the control device 45 executes the program stored in the storage device 44 or the ROM of the control device 45.

The control device 45 realizes, by executing the token control program 44A, a token controller 45A that controls the token.

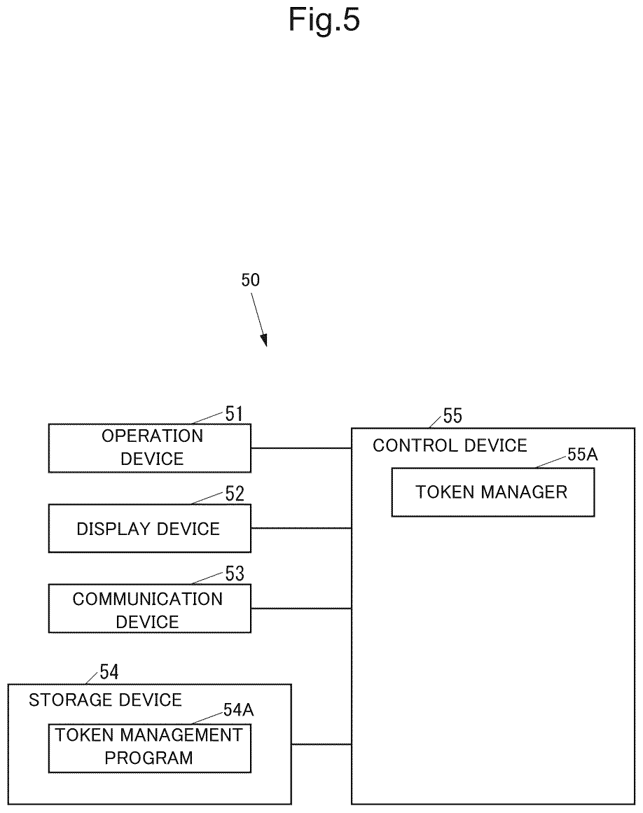

FIG. 5 s a block diagram showing a configuration of the cache system 50 constituted of a single computer;

As shown in FIG. 5, the cache system 50 includes an operation device 51, a display device 52, a communication device 53, a storage device 54, and a control device 55.

The operation device 51 includes, for example, a keyboard and a mouse for inputting various operations. The display device 52 includes, for example, an LCD for displaying various types of information. The communication device 53 performs communication with an external device, via a network such as a LAN or the internet, or directly through wired or wireless communication. The storage device 54 includes a non-volatile memory unit such as a semiconductor memory or an HDD, for storing various types of information. The control device 55 controls the overall operation of the cache system 50.

The storage device 54 can store therein a token management program 54A, for managing the token. The token management program 54A may be, for example, installed in the cache system 50 during the manufacturing process thereof, additionally installed in the cache system 50 from an external storage medium such as a USB memory, or additionally installed in the cache system 50 from the network.

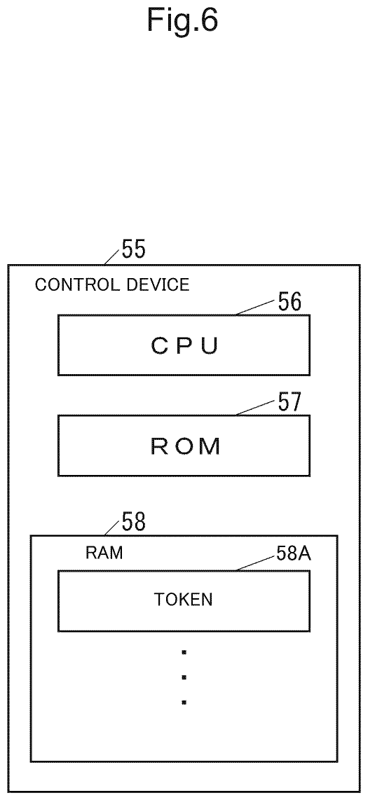

FIG. 6 is a block diagram showing a configuration of the control device 55. As shown in FIG. 6, the control device 55 includes, for example, a CPU 56, a ROM 57 containing programs and various types of data, and a RAM 58 serving as the operating region for the CPU 56. The CPU 56 executes the program stored in the storage device 54 (see FIG. 5) or the ROM 57.

The RAM 58 can store therein a token 58A. The RAM 58 may store therein tokens configured similarly to the token 58A, in addition to the token 58A. The RAM 58 serves as the token storage for retaining the token.

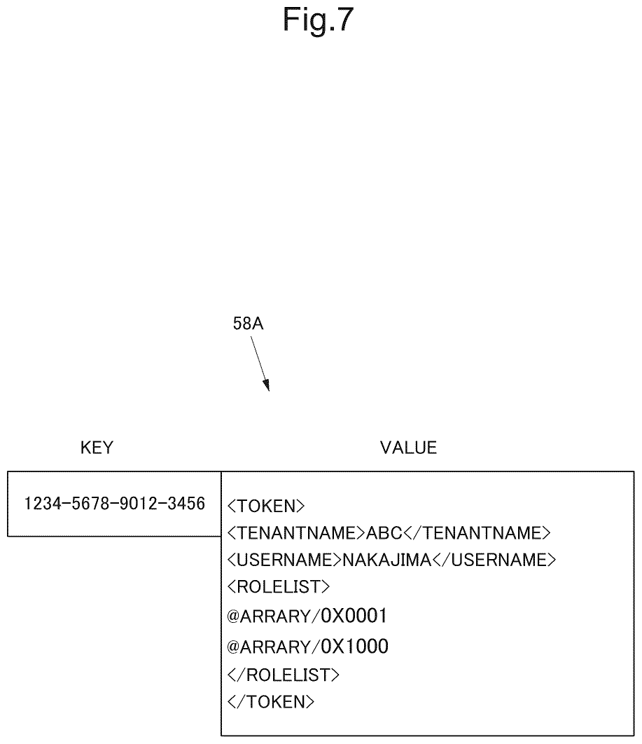

FIG. 7 presents an example of the token 58A. As shown in FIG. 7, the token 58A has a data structure of a document format, such as a hypertext markup language (HTML) format of a key-value type, composed of a key serving as the identification information of the token, and values representing the contents of the token.

The values of the token 58A include the name of the tenant to which the user belongs, the user name, and the role ID of the role assigned to the user. The type of the information to be included in the values may be designed as desired.

As shown in FIG. 5, the control device 55 realizes, by executing the token management program 54A, ta token manager 55A that manages the token.

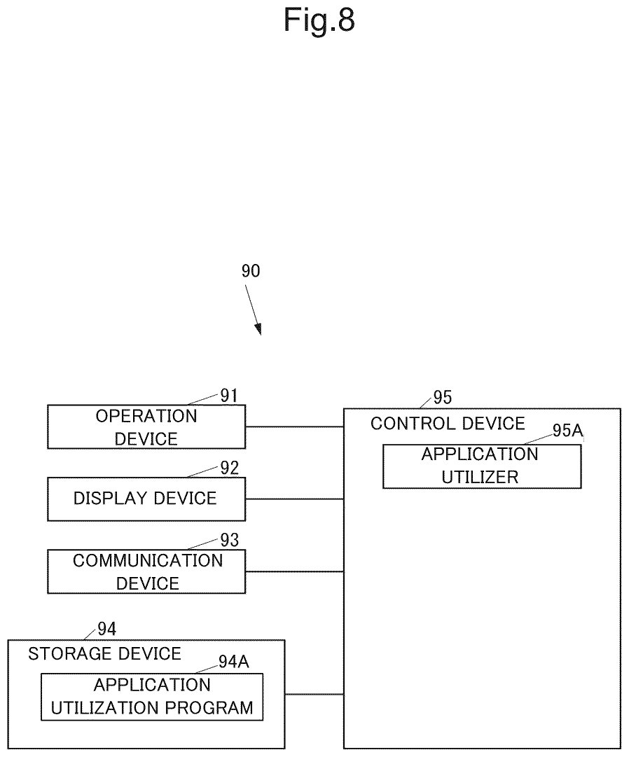

FIG. 8 is a block diagram showing a configuration of the user terminal 90, constituted of a PC. As shown in FIG. 8, the user terminal 90 includes an operation device 91, a display device 92, a communication device 93, a storage device 94, and a control device 95.

The operation device 91 includes, for example, a keyboard and a mouse for inputting various operations. The display device 92 includes, for example, an LCD for displaying various types of information. The communication device 93 performs communication with an external device, via a network such as a LAN or the internet, or directly through wired or wireless communication. The storage device 94 includes a non-volatile memory unit such as a semiconductor memory or an HDD, for storing various types of information. The control device 95 controls the overall operation of the user terminal 90.

The storage device 94 can store therein an application utilization program 94A, for utilizing the application provided by the application provision system 20. The application utilization program 94A may be, for example, installed in the user terminal 90 during the manufacturing process thereof, additionally installed in the user terminal 90 from an external storage medium such as a USB memory, or additionally installed in the user terminal 90 from the network.

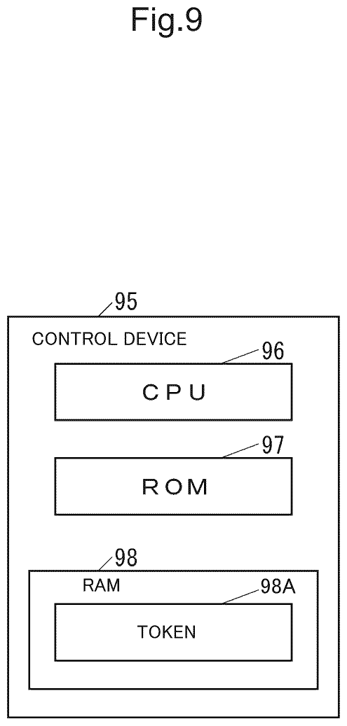

FIG. 9 is a block diagram showing a configuration of the control device 95. As shown in FIG. 9, the control device 95 includes, for example, a CPU 96, a ROM 97 containing programs and various types of data, and a RAM 98 serving as the operating region for the CPU 96. The CPU 96 executes the program stored in the storage device 94 (see FIG. 8) or the ROM 97.

The RAM 98 can store therein a token 98A. The configuration of the token 98A is similar to that of the token 58A (see FIG. 7).

As shown in FIG. 8, the control device 95 realizes, by executing the application utilization program 94A, an application utilizer 95A that utilizes the application provided by the application provision system 20. The application utilizer 95A is aware of the URL for making access to the token control system 40.

Operations of the information processing system 10 will now be described hereunder. First, an operation of the information processing system 10, performed when the user logs in to the application provision system 20, will be described.

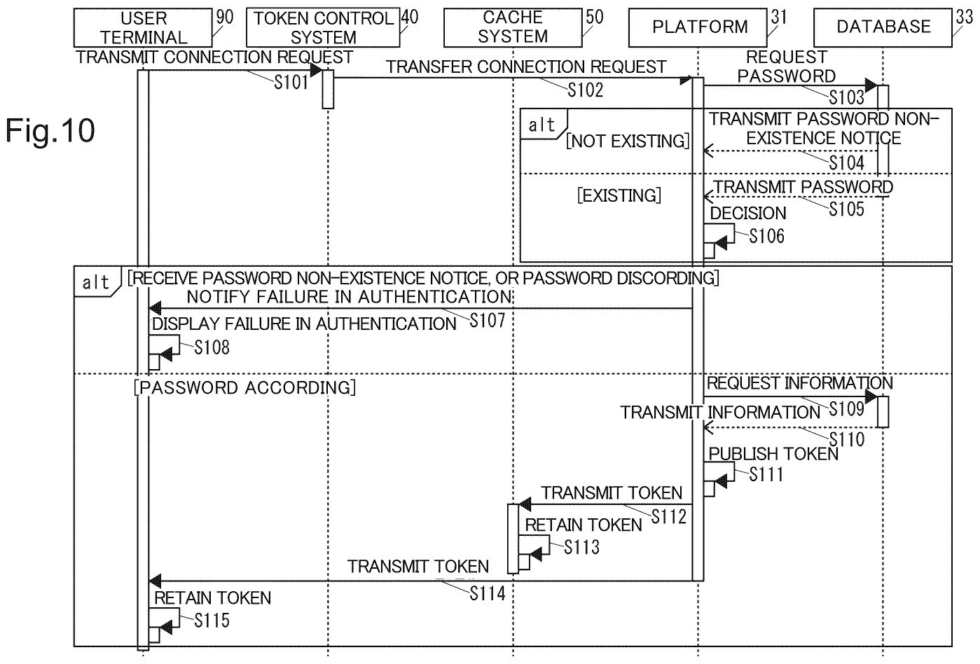

FIG. 10 is a sequence chart showing the operation of the information processing system 10, performed when the user logs in to the application provision system 20.

The user can instruct the user terminal 90 to log in to the application provision system 20, by inputting the combination of the user name and the password to the user terminal 90, through the operation device 91.

Upon receipt of the instruction to log in to the application provision system 20, the application utilizer 95A of the user terminal 90 transmits, as shown in FIG. 10, a request for connection to the application provision system 20 (hereinafter, “connection request”) to the token control system 40, using “https://example.com/auth” which is the URL for making access to the token control system 40 (step S101).

The application utilizer 95A includes the combination of the user name and the password, inputted through the operation device 91, in the connection request of step S101.

Upon receipt of the connection request transmitted at step S101, the token controller 45A of the token control system 40 transfers the connection request received, to the platform 31 (step S102).

Upon receipt of the connection request transferred at step S102, the platform 31 requests the database 33 to provide the password associated with the user name included in the connection request received (step S103).

The database 33 confirms the password associated with the user name included in the request of step S103, according to the user management table 33B.

When the password requested at step S103 is not included in the user management table 33B, the database 33 transmits a notice to the effect that the password requested at step S103 does not exist (hereinafter, “password non-existence notice”), to the platform 31 (step S104).

When the password requested at step S103 is found, the database 33 transmits the password requested at step S103 to the platform 31 (step S105).

Upon receipt of the password transmitted at step S105, the platform 31 decides whether the password included in the connection request and the password received from the database 33 accord with each other (step S106).

Upon receipt of the password non-existence notice transmitted at step S104, or upon deciding at step S106 that the password included in the connection request and the password received from the database 33 discord from each other, the platform 31 notifies the user terminal 90 that the authentication has failed (step S107).

Upon receipt of the notice of step S107, the application utilizer 95A of the user terminal 90 causes the display device 91 to display a message to the effect that the authentication has failed (step S108).

In contrast, upon deciding at step S106 that the password included in the connection request and the password received from the database 33 accord with each other, the platform 31 requests the database 33 to provide the information associated with the user name included in the connection request (step S109).

For example, the platform 31 requests the database 33 to provide the tenant name and the role ID, associated with the user name included in the connection request.

Upon receipt of the request for the tenant name and the role ID, associated with the user name included in the connection request, the database 33 identifies the user ID associated with the user name included in the request of step S109, according to the user management table 33B.

The database 33 confirms the tenant name associated with the user ID identified as above, according to the tenant management table 33A, and also confirms the role ID associated with the user name included in the request of step S109, according to the user management table 33B.

The database 33 transmits the information requested at step S109 to the platform 31, in response to the request of step S109 (step S110).

Upon receipt of the information transmitted at step S110, the platform 31 publishes the token associated with the user terminal 90, on the basis of the information received (step S111). The platform 31 also generates the key of the token, at step S111.

After step S111, the platform 31 transmits the token published at step S111, to the cache system 50 (step S112).

Upon receipt of the token transmitted at step S112, the token manager 55A of the cache system 50 stores the received token in the RAM 58 (step S113).

After step S112, the platform 31 transmits the token published at step S111 to the user terminal 90 (step S114). The transmission of step S114 may be executed through the token control system 40. The token transmitted to the user terminal 90 may be, for example, encrypted by the token control system 40.

Upon receipt of the token transmitted at step S114, the application utilizer 95A of the user terminal 90 stores the received token in the RAM 98 (step S115).

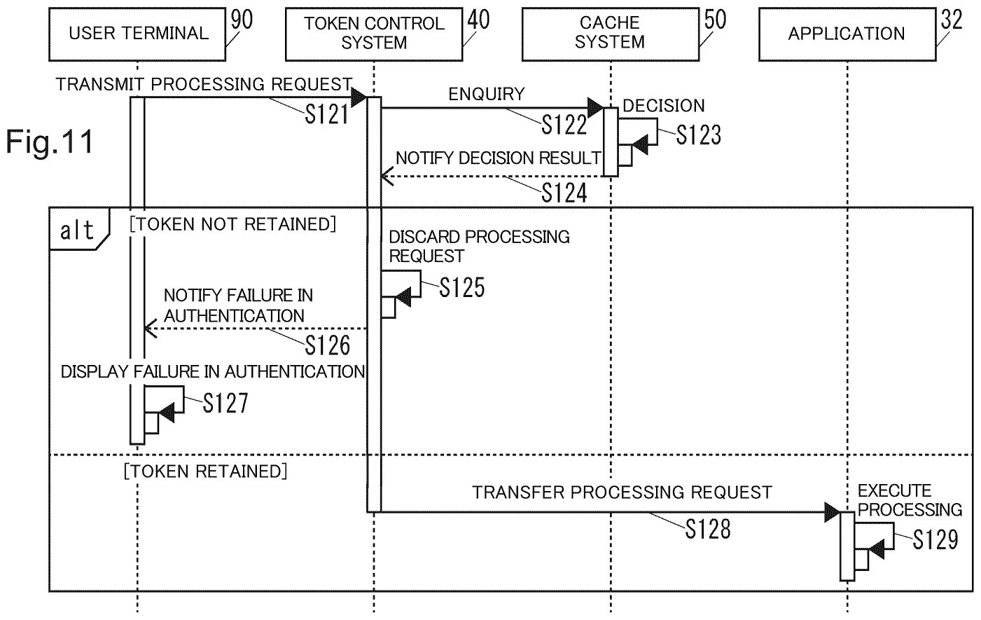

Hereunder, an operation of the information processing system 10, performed when the user utilizes the application 32, will be described. FIG. 11 is a sequence chart showing the operation of the information processing system 10, performed when the user utilizes the application 32.

The user can instruct, in the log-in state to the application provision system 20, the user terminal 90 to utilize the application 32, through the operation device 91.

Upon receipt of the instruction to utilize the application 32, the application utilizer 95A of the user terminal 90 transmits a request for execution of the application 32 (hereinafter, “processing request”) to the token control system 40, using a URL “https://example.com/auth/app1”, created by adding, for example, “app1” indicating the application 32, to “https://example.com/auth”, which is the URL for making access to the token control system 40, as shown in FIG. 11 (step S121).

The application utilizer 95A sets the key of the token stored in the RAM 98 at step S115, as the hypertext transfer protocol (HTTP) header of the processing request to be transmitted at step S121. In the processing request of step S121, the key of the token may be encrypted.

Upon receipt of the processing request transmitted at step S121, the token controller 45A of the token control system 40 enquires the cache system 50 whether the token associated with the processing request that has been received is stored in the cache system 50 (step S122). In the case where the key is encrypted in the processing request, the token controller 45A decrypts the key.

Upon receipt of the enquiry of step S122, the token manager 55A of the cache system 50 decides whether the token associated with the key included in the processing request is stored in the RAM 58 (step S123). Since the token is stored in the RAM 58 in the key-value format, the time required for the token manager 55A to search for the token is O(1).

After step S123, the token manager 55A notifies the decision result of step S123, to the token control system 40 (step S124).

In the case where the token controller 45A of the token control system 40 receives the notice of the decision result of step S124, to the effect that the token associated with the key included in the processing request is not stored, the token controller 45A discards the processing request (step S125).

After step S125, the token controller 45A notifies the user terminal 90 that the authentication has failed (step S126).

Upon receipt of the notice of step S126, the application utilizer 95A of the user terminal 90 causes the display device 91 to display the message to the effect that the authentication has failed (step S127).

In the case where the token controller 45A of the token control system 40 receives the notice of the decision result of step S124, to the effect that the token associated with the key included in the processing request is stored, the token controller 45A transfers the processing request to the application 32, which is the object of the processing request (step S128). In other words, the token controller 45A authorizes the user terminal 90 to execute the application 32.

Upon receipt of the processing request transferred at step S128, the application 32 executes the processing according to the processing request (step S129).

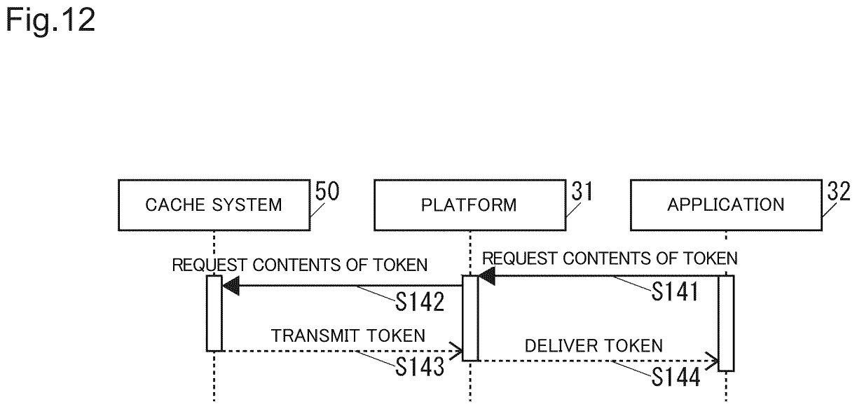

Hereunder, an operation of the information processing system 10, performed when the application 32 acquires the content of the token, will be described. FIG. 12 is a sequence chart showing the operation of the information processing system 10, performed when the application 32 acquires the content of the token.

In the case where, during the execution of the processing, it becomes necessary to acquire the contents of the token, such as the tenant ID of the tenant to which the user belongs, or the role of the user, the application 32 requests the platform 31 to provide the contents of the token, as shown in FIG. 12 (step S141). The application 32 includes the key included in the processing request, in the request of step S141.

Upon receipt of the request of step S141, the platform 31 requests the cache system 50 to provide the contents of the token, requested at step S141 (step S142). The platform 31 includes the key included in the request of step S141, in the request of step S142.

Upon receipt of the request of step S142, the token manager 55A of the cache system 50 transmits the token associated with the key included in the request of step S142, out of the tokens stored in the RAM 58, to the platform 31 (step S143).

Upon receipt of the token transmitted at step S143, the platform 31 delivers the received token to the application 32 (step S144).

Now, in the case of the aforementioned known technique, an increase in amount of information included in the token leads to an increase in time required for the computer that publishes the application to verify the token for authorizing the client to execute the application.

According to the foregoing embodiment, in contrast, the token published by the platform 31 is key-value type data composed of the key serving as the identification information of the token, and the values representing the contents of the token, and the token control system 40 authorizes the user terminal 90 to execute the application 32, when the token including the key transmitted from the user terminal 90 is included in the tokens stored in the RAM 58 of the cache system 50 (step S128).

Therefore, the execution of the application 32 can be quickly authorized, regardless of the increase in amount of information included in the token.

In general, an upper limit of the number of times of connection per unit time is imposed on the database. However, according to the foregoing embodiment, since the token has a data structure of the document format, the token control system 40 can increase the number of times of verification of the token per unit time, compared with the case where the token is managed by the database.

However, in the token control system 40, the token may be managed by the database.

According to the embodiment, in the application provision system 20, the token is stored in the RAM 58, which can be quickly accessed. Accordingly, the token can be accessed more quickly, compared with the case where the token is stored in a storage device other than the RAM, such as an HDD. As result, the authorization for the execution of the application 32 can be quickly attained.

In the application provision system 20, however, the token may be stored in a storage device other than the RAM.

According to the embodiment, in addition, the application 32 acquires the contents of the token stored in the RAM 58 of the cache system 50 (step S141 to step S144), which is separately provided from the database 33 for managing the information utilized by the platform 31 and the application 32, in the application provision system 20.

Therefore, when the execution of the application 32 is to be authorized, the database 33, which manages the information utilized by the platform 31 and the application 32, can be exempted from being subjected to a load.

According to the embodiment, the cache system 50 is realized by the computer that is different from both of the application execution system 30 and the token control system 40. However, the cache system 50 may be realized by the computer common to either the application execution system 30, or the token control system 40.

However, the number of tokens to be retained by the cache system 50 increases with the increase in number of user terminals, and therefore the storage capacity of the cache system 50 has to be upgraded, according to the increase in number of user terminals. Therefore, it is preferable that the cache system 50 is realized by the computer that is different from both of the application execution system 30 and the token control system 40.

Further, the computer-readable, non-transitory recording medium, having the token control program 44A according to the embodiment recorded thereon, can be exemplified by a hard disk, a CD-ROM, a DVD-ROM, or a semiconductor memory.

While the present disclosure has been described in detail with reference to the embodiments thereof, it would be apparent to those skilled in the art that various changes and modifications may be made therein within the scope defined by the appended claims.

What is claimed is;:

1. A token control system comprising:
a communication device that communicates with an external device; and
a token controller including a processor, and configured to control a token necessary for executing an application that acts on a platform, when the processor executes a token control program,
wherein the token is key-value type data including a key serving as identification information of the token, and values representing contents of the token, and
when the communication device receives the key transmitted from a user terminal, and the tokens published by the platform, and stored in a predetermined token storage, include a token including the key received by the communication device, the token controller authorizes the user terminal to execute the application.

2. The token control system according to claim 1,
wherein the token is data having a data structure of a document format.

3. The token control system according to claim 1,
wherein, when the token including the key received by the communication device is not included in the tokens stored in the token storage, the token controller notifies failure in authentication to the user terminal, through the communication device.

4. A computer-readable, non-transitory recording medium having a token control program recorded thereon, the token control program being configured to cause a computer, including a communication device that communicates with an external device, and a processor, to act as a token controller that controls a token necessary for executing an application that acts on a platform, when the processor executes the token control program,
wherein the token is key-value type data including a key serving as identification information of the token, and values representing contents of the token, and
when the communication device receives the key transmitted from a user terminal, and the tokens published by the platform, and stored in a predetermined token storage, include a token including the key received by the communication device, the token controller authorizes the user terminal to execute the application.

5. An application provision system comprising:
a platform;
an application that acts on a platform;
a communication device that communicates with an external device;
a token controller including a processor, and configured to control a token necessary for executing the application that acts on the platform, when the processor executes a token control program; and
a token storage that stores therein tokens published by the platform,
wherein the token is key-value type data including a key serving as identification information of the token, and values representing contents of the token, and
when the communication device receives the key transmitted from a user terminal, and the tokens stored in the token storage, include a token including the key received by the communication device, the token controller authorizes the user terminal to execute the application.

6. The application provision system according to claim 5,
wherein the token storage includes a random-access memory.

7. The application provision system according to claim 5, further comprising a database for managing information utilized by the application and the platform, separately from the token storage,
wherein the application acquires the contents of the token retained by the token storage.
